(19) United States
(12) Patent Application Publication
(10) Pub. No.: US 2005/0095350 A1
(43) Pub. Date: May 5, 2005

(54) Nutritive food source including controlled energy release carbohydrate

(75) Inventors: Frank W. Barresi, Iowa City, IA (US); Jiao Wang, Muscatine, IA (US)

Correspondence Address: BANNER & WITCOFF, LTD., TEN SOUTH WACKER DRIVE, SUITE 3000, CHICAGO, IL, 60606, US

(73) Assignee: Grain Processing Corporation, Muscatine, IA (US)

(21) Appl. No.: 10/947,060

(22) Filed: Sep. 22, 2004

Related U.S. Application Data
(60) Provisional application No. 60/504,713, filed on Sep. 22, 2003.

(51) Int. Cl. A23L 1/05

(52) U.S. Cl. 426/658

(57) ABSTRACT

Disclosed are food products, in particular sports drinks and energy bars, that include isomalto-oligosaccharides. In one embodiment, at least 35% of the nutritive carbohydrate content of the food product comprise an isomalto-oligosaccharide. In another embodiment, at least 35% of the caloric content of the food product is attributed to the isomalto-oligosaccharide. In another embodiment, the isomalto-oligosaccharide is present in an amount effective to provide a nutritive caloric content of at least 50 kcal.

### FIELD OF THE INVENTION

The invention relates to the use of controlled energy release carbohydrates in food and drinks.

### BACKGROUND OF THE INVENTION

The increase incidence of type 2 diabetes mellitus has lead to the need to develop foods to control blood glucose levels in such individuals. In addition, in the sports market, there is a need to provide nutritional- and sports-based products such as health bars or drinks that can provide a constant, sustained energy release over a long period of time.

Ideally, a slowly digested product should be fully or almost fully digestible, yet should deliver nutritional calories over an extended period of time. Typically, fully digestible carbohydrates are rapidly digested, thus causing a spike in blood glucose levels soon after ingestion (a hyperglycemic condition) and a subsequent drop in blood glucose level (a hypoglycemic condition) due to overexpression of insulin. These conditions are not desired even in healthy persons, and potential ill effects such as increased risk of cardiovascular disease, blurred vision, loss of consciousness, and diminished mental acuity can be attributed to the fluctuations in blood glucose levels (see, e.g., U.S. Pat. No. 5,695,803, and PCT Publication WO 96/31129).

The prior art has provided numerous controlled energy release products. Hydrogenated starch hydrolyzates such as Lycasin® (Roquette Freres) and Hystar® (SPI Polyols) are known in the literature to be digested more slowly than their non-hydrogenated products. The digestion products of a hydrogenated starch hydrolyzed (HSH) are glucose, sorbitol, and maltitol, and the sorbitol and maltitol components of the mixture are digested slowly relative to glucose (Dwivedi, Food Science & Technology Books, Vol. 17, 1986, p. 165-83). Drawbacks of HSH's include their relatively high osmolality and high level of sorbitol and maltitol digestion products that can cause cramping and diarrhea.

The prior art also has provided food systems that contain a mixture of rapidly digestible, slowly digestible and non-digestible products. For example, WO 96/31129 purports to teach that a combination of rapid digested carbohydrate with a slowly digested complex carbohydrate such as raw corn starch, in conjunction with proteins and fats, can control blood glucose levels. However, the slowly digested product is a raw starch, which is not fully digested and is only amenable to use in solid food products due to its lack of cold water solubility.

Chemically modified starches such as oxidized, dextrinized and etherified starches have also been examined as candidates for controlled energy release (J. Agric. Food Chem. 1999, 47, 4178). In general, it has been found that the more chemically modified a material is, the less digestible the material becomes. Most chemically modified starches tend to have no digestibility or very low digestibility and are deemed resistant starches or soluble fiber.

### BRIEF SUMMARY OF THE INVENTION

The present invention is directed to nutritive products, specifically food and drink products, that contain a mixture of slow energy release isomalto-oligosaccharides. The mixture is slowly digested to allow a slow and even release of carbohydrate energy relative to the consumption of a like amount of more digestible carbohydrates. Digestible carbohydrates are digested by enzymatic action to form glucose, which is used as the principal mammalian energy source. Because the isomalto-oligosaccharides used in conjunction with the invention are digested more slowly than common simple sugars such as sucrose and maltose, glucose and hence energy are made available relatively more slowly.

In accordance with one embodiment of the invention, a nutritive product is provided, wherein at least 35% of the nutritive carbohydrate content in the nutritive product comprises an isomalto-oligosaccharide. In accordance with another embodiment, not mutually exclusive with respect to the previously stated embodiment, at least 35% of the nutritive caloric content of the nutritive product is attributed to said isomalto-oligosaccharide. In connection with preferred embodiments, the mixture is water soluble, spray dryable, and easy and practical to use in food formulations. Preferably, the mixture includes panose and isomaltose and other DP2-3 carbohydrates in an amount of at least 20% of the isomalto-oligosaccharides in the mixture. The invention also encompasses the inclusion of hydrogenated isomalto-oligosaccharides in a food or beverage to provide nutritive value. Also encompassed by the invention is an energy product in the form of a discrete solid or liquid food product in which the nutritive caloric value of the isomalto-oligosaccharide is at least 50 kcal.

The invention encompasses a method of preparing a mixture of isomalto-oligosaccharides in which reaction conditions are selected to vary the relative amounts of various carbohydrate fractions in the resultant product. Also encompassed by the invention is a method for preparing a nutritive product, the method including providing a mixture of isomalto-oligosaccharides that has been so prepared, and blending the mixture with other nutritive caloric sources to form a nutritive product.

### BRIEF DESCRIPTION OF THE DRAWINGS

FIG. 1 is a graphical illustration of the in vitro digestibility assay data shown in Table I.

FIGS. 2 and 3 are graphical illustrations of the rate data shown in Table III.

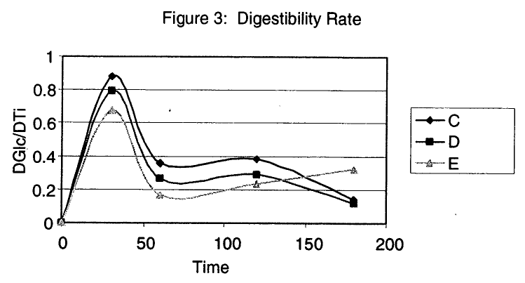

### DETAILED DESCRIPTION OF THE PREFERRED EMBODIMENTS

The invention is related to food and drink products that digest slowly and therefore provide a sustained energy release over a long period of time. In particular, the invention is related to food and drink products containing an isomalto-oligosaccharide mixture that provides slow consistent energy release of glucose.

Isomalto-oligosaccharides (IMOs) are carbohydrates that are contain two or more glucosyl units linked by an α-(1-6) linkage. Preferably, the isomalto-oligosaccharide comprises the reaction product of an acid or enzyme catalyzed reversion of glucose or a glucose-containing oligosaccharide (e.g. maltose or a higher α(1,4) linked material). The preferred starting material is glucose or maltose or mixtures thereof (e.g. a maltose syrup). The preferred form of catalysis is enzymatic catalysis, and generally alpha bonds should be formed, with α(1,6) bond formation preferably predominating over other bonds. Beta linkages are possible but will lead to a product that is essentially indigestive to the extent of the β bonds. Isomalto-oligosaccharides also include mixtures of saccharides in which 80% or more of the saccharide carbohydrates in the mixture have a DP of less than 10 (preferably 90% or more) and in which the DP2 through DP4 species include at least some α(1,6) bonds (and usually some α(1,2), α(1,3), and α(1,4) bonds). Two commercially available isomalto-oligosaccharides are IMO-500 and IMO-900, available from Showa. The lower carbohydrate profile of IMO-900 is believed to be as follows:
3% glucose
30% isomaltose
5.5% maltose
6% other DP2
3.5% maltotriose
11.4% panose
15.7% isomaltotriose
16.8% other DP4
6.8% DP5
1.3% DP6

One known method of producing these products is from liquefied starch that is treated with α and β-amylases and an Aspergillus niger transglucosidase. The products are known to promote the growth of bifidobacteria, and in general can be considered healthy carbohydrates useful to improve gastrointestinal health. They are approximately 75% digested relative to maltose and their level of digestibility can be related to molecular weight, with higher molecular weight materials generally being less digestible (K. Bucholz and J. Seibel, Ch 6 in Oligosaccharides in Food and Agriculture, G. Eggleston and G. Cote ed.). Heretofore, although isomalto-oligosaccharides have been used in food products in small amounts in applications such as bifidobacteria promotion (U.S. Pat. No. 4,782,045), and beer production (WO2002020712), and in other applications such as fabric care (WO 2000024856), as a binder (U.S. Pat. No. 5,411,945) and in ink manufacture (EPA 1146097), the prior art has not taught to use such compounds as a principal nutritive source in a food product such as a sports bar or energy drink.

Isomaltose, isomaltotriose, panose, isomaltotetraose, and isomaltopentaose are typical sugars in this group. The blend is digested slowly relative to sucrose and glucose, thus allowing for a slow release of energy over a period of time. The levels of panose and isomaltose represent a significant proportion of the isomalto-oligosaccharides mixture and can be selected to tailor the controlled release of glucose. For instance, mixtures can be made that have more panose, which are digested more quickly than mixtures that have higher levels of isomaltose. In the examples set forth below, mixtures having about 27% panose and 7% isomaltose digest more quickly than mixtures having about 24% panose and 11% isomaltose. Those skilled in the art will appreciate that many other factors, such as enzyme selection, starting material, and time and temperature of reactions may be selectively modified to adjust the components of the resulting composition.

The isomalto-oligosaccharides mixture can be made via a number of processes including dextran and/or pullulan hydrolysis, the action of dextransucrase on sucrose and glucose, or by the action of transglucosidase on a high maltose syrup or other suitable starting material. The resulting products are rich in isomaltose, panose, isomaltotriose and higher molecular weight oligosaccharides containing predominantly α(1-6) linkages.

In addition to the slow energy release properties of isomalto-oligosaccharides, in general these mixtures are also water-soluble and spray dryable. Thus, the mixtures can be used either in the liquid (syrup) or solid (spray dried powder) form and are easy and practical to use in food formulations.

A suitable nutritive food product, such as a food or energy bar, comprises nutritive carbohydrates wherein at least 35% of the nutritive carbohydrates comprise an isomalto-oligosaccharide. By “nutritive carbohydrates” is contemplated carbohydrates that are digestible in vitro in 24 hours in accordance with the procedure specified in Example 1. Because some of the carbohydrate content of the isomalto-oligosaccharide is not nutritive, the ratio of nutritive carbohydrate to total carbohydrate should account only for the nutritive carbohydrate portion of the isomalto-oligosaccharide. In some embodiments, at least 40% of the nutritive carbohydrates comprise isomalto-oligosaccharide, in some embodiments, at least 45%, in some embodiments, at least 50%, in some embodiments, at least 55%, in some embodiments, at least 60%, in some embodiments, at least 65%, in some embodiments, at least 70%, in some embodiments, at least 75%, in some embodiments, at least 80%, in some embodiments, at least 85%, in some embodiments, at least 90%, in some embodiments, at least 95%, and in some embodiments, 100% of the nutritive carbohydrates in the food product comprise isomalto-oligosaccharide. Where other saccharides are present (e.g. maltose, which can be a component of the isomalto-oligosaccharide), the ratio generally should be determined based on the carbohydrate profile of the starting isomalto-oligosaccharide material used to prepare the food product.

In accordance with another embodiment, at least 35% of the nutritive caloric content of the food product is attributed to the isomalto-oligosaccharide. In some embodiments, at least 40% of the caloric content is attributed to the isomalto-oligosaccharide, in some embodiments, at least 45%, in some embodiments, at least 50%, in some embodiments, at least 55%, in some embodiments, at least 60%, in some embodiments, at least 65%, in some embodiments, at least 70%, in some embodiments, at least 75%, in some embodiments, at least 80%, in some embodiments, at least 85%, in some embodiments, at least 90%, in some embodiments, at least 95%, and in some embodiments, 100% of the caloric content is attributed to the isomalto-oligosaccharide.

In accordance with another embodiment of the invention, the isomalto-oligosaccharide is present in a discrete food product, such as an individual sports bar or individually allocated amount of sports drink, in an amount such that the nutritive value provided by the isomalto-oligosaccharide is at least 50 kcal, more preferably, at least 75 kcal, more preferably, at least 100 kcal, more preferably, at least 125 kcal, more preferably, at least 150 kcal, more preferably, at least 175 kcal, and more preferably, at least 200 kcal. Other nutritive products may be included in the discrete food product, or the sole source of nutritive value in the food product may be the isomalto-oligosaccharides.

Hydrogenated isomalto-oligosaccharides also may be used in conjunction with the invention. Such materials may be used in amounts comparable to the non-hydrogenated isomalto-oligosaccharide. The hydrogenated products typically are not strictly speaking carbohydrates, but may be in a nutritive product in a weight amount equal to or greater than a like amount of non-hydrogenated product. Thus, although the nutritive value of a hydrogenated isomalto-oligosaccharide is ordinarily expected to be less than that of the non-hydrogenated isomalto-oligosaccharide counterpart, in weight amount the products may be used in similar amounts.

Suitable nutritive products include any form of substance that is comestible by the intended recipient, but in preferred embodiments, the food product takes the form of a human energy bar or sports drink. The food or energy bar may contain any ingredient suitable for use in such bars. Other ingredients typically used in energy bars include materials such as whole grain rolled oats, brown rice and peanut butter, sugar, canola oil, soy protein, peanut flour, soy lecithin, and baking soda. Other carbohydrate sources may make up the balance of the carbohydrates in the product, including but not limited to oligosaccharides including fructo-oligosaccharides, xylo-oligosaccharides, galacto-oligosaccharides, and malto-oligosaccharides, and other sugars, such as sucrose, maltose, maltotriose, fructose, lactose, mannose, and so forth.

When the isomalto-oligosaccharide is used in connection with a sports drink, the drink may also contain a suitable protein sources such as soy, meat or whey; fat such as from safflower oil, and various flavorants. The balance of the drink preferably is water.

The following examples are provided to illustrate the invention, but should not be construed as limiting the invention in scope.

### EXAMPLES

### Example 1

### Preparation of Isomalto-Oligosaccharide-A

High maltose corn syrup (Satin Sweet™, 65% maltose, 85% solids syrup, commercially available from Cargill) 60 g (dsb) was diluted with 130 g of distilled water to yield a 30% solids solution. Transglucosidase L-500 (Genencor), 0.102 mL (0.2% on carbohydrate solids) was introduced via syringe into the stirred solution. The solution was heated to 60° C. and pH adjusted from 3.8 to 4.1 with 0.1N NaOH. The solution was held at temperature for 72 hours and then quenched by submerging the reaction flask in boiling water for 10 minutes. The resulting carbohydrate profile of the mixture is shown in Table 1.

### Example 2

### Preparation of Isomalto-Oligosaccharide-B

High maltose corn syrup (Satin Sweet™, 65% maltose, 85% solids syrup) 100 g (dsb) was diluted with 84 g of distilled water to yield a 50% solids solution. Transglucosidase L-500 (Genencor), 0.17 mL (0.2% on carbohydrate solids) was introduced via syringe into the stirred solution. The solution was heated to 60° C. and pH adjusted from 3.6 to 4.1 with 0.1N NaOH. The solution was held at temperature for 72 hours and then quenched by submerging the reaction flask in boiling water for 10 minutes. The resulting carbohydrate profile of the mixture is shown in Table 1.

### Example 3-5

### Preparation of Isomalto-Oligosaccharide-C, D, E

High maltose corn syrup (Satin Sweet™, 65% maltose, 85% solids syrup) 80 g (dsb) was diluted with 106 g of distilled water to yield a 40% solids solution. Transglucosidase L-500 (Genencor), 0.136 mL (0.2% on carbohydrate solids) was introduced via syringe into the stirred solution. The solution was heated to 60° C. and pH adjusted from 3.6 to 4.5 with 0.1N NaOH. Aliquots of the reaction mixture were pulled at different times and quenched by submerging the reaction flask in boiling water for 10 minutes to give the following samples:
C-31 hour reaction time.
D-48 hour reaction time.
E-72 hour reaction time.

The resulting carbohydrate profiles of the mixtures are shown in Table 1.

TABLE I
Carbohydrate Profile of Isomalto-Oligosaccharide Samples:

| | | | | | | | | | % known |
|---|---|---|---|---|---|---|---|---|---|
| Sample | Glucose | Maltose | Maltotriose | Isomaltose | Panose | Isomaltotriose | Total | >DP 4 | 1-6 |
| A | 21.6 | 11.8 | 2.5 | 7.5 | 26.5 | 1.4 | 71.3 | 28.7 | 35.4 |
| B | 17.1 | 16.5 | 5.5 | 6.7 | 27.3 | 1.4 | 74.5 | 25.5 | 35.4 |
| C | 13.4 | 17.1 | 8.9 | 7.6 | 26.9 | 0.8 | 74.7 | 25.3 | 35.3 |
| D | 14.3 | 11.6 | 5.1 | 11 | 24.1 | 1.5 | 67.6 | 32.4 | 36.6 |
| E | 14.9 | 8.7 | 2.7 | 14 | 18.2 | 2.3 | 60.8 | 39.2 | 34.5 |

Not reflected in the foregoing table are amounts of α(1,2) and α(1,3) linked saccharides. The percentages expressed in the foregoing table are based on 100% of the measured amounts of the foregoing materials as determined via gas chromatographic methods.

TABLE II
Digestibility Data*

| | | | | % | | |
|---|---|---|---|---|---|---|
| Time | MALTRIN ® | | | Glucose | | |
| (min) | M100** | A | B | C | D | E |
| 0 | 1.7 | 19.8 | 17 | 15.2 | 17 | 18.3 |
| 30 | 71.5 | 41.2 | 40.2 | 41.7 | 40.9 | 38.6 |
| 60 | 89.1 | 49.6 | 49.1 | 52.6 | 48.9 | 43.6 |
| 120 | 96.2 | 57.9 | 57.7 | 64.2 | 57.7 | 50.7 |
| 180 | 96.2 | 63.5 | 63.6 | 68.5 | 61.2 | 60.4 |
| 1440 | 98.1 | 76.6 | 76 | 76.7 | 75 | 71.7 |

*protocol: adapted from J. Food Sci., Vol. 53, No. 4, 1988, pp. 1204-1207
**Maltodextrin available from Grain Processing Corporation of Muscatine, Iowa having a carbohydrate profile as disclosed in U.S. Pat. No. 6,613,898.

The carbohydrate mixtures prepared in accordance with the Examples were not completely digested in vitro even after 24 hours, thus indicating that at least some portion of the carbohydrates constitute dietary fiber (i.e. non nutritive within the purview of the invention).

TABLE III
Digestibility Rate Data

| | | M100 | | A | | B | | C | | D | | E | |
|---|---|---|---|---|---|---|---|---|---|---|---|---|---|
| Time | Δtime | | ΔGlc/ | | ΔGlc/ | | ΔGlc/ | | ΔGlc/ | | ΔGlc/ | | ΔGlc/ |
| (min) | (min) | ΔGlc | Δtime | ΔGlc | Δtime | ΔGlc | Δtime | ΔGlc | Δtime | ΔGlc | Δtime | ΔGlc | Δtime |
| 0 | 0 | 0 | 0 | 0 | 0 | 0 | 0 | 0 | 0 | 0 | 0 | 0 | 0 |
| 30 | 30 | 69.8 | 2.33 | 21.4 | 0.71 | 23.2 | 0.77 | 26.5 | 0.88 | 23.9 | 0.80 | 20.3 | 0.68 |
| 60 | 30 | 17.6 | 0.59 | 8.4 | 0.28 | 8.9 | 0.30 | 10.9 | 0.36 | 8.0 | 0.27 | 5.0 | 0.17 |
| 120 | 60 | 7.1 | 0.24 | 8.3 | 0.28 | 8.6 | 0.29 | 11.6 | 0.39 | 8.8 | 0.29 | 7.1 | 0.24 |
| 180 | 60 | 0 | 0 | 5.6 | 0.19 | 5.9 | 0.20 | 4.3 | 0.14 | 3.5 | 0.12 | 9.7 | 0.32 |

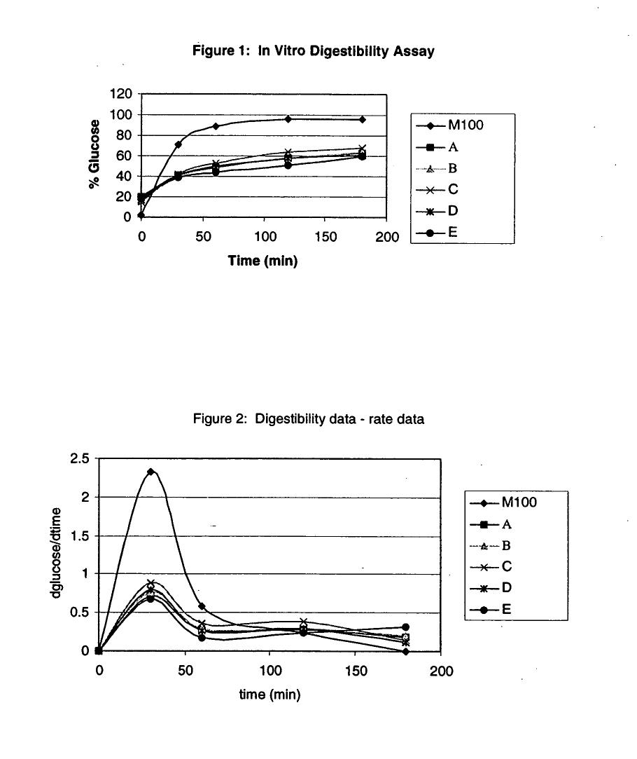

FIG. 1 and Table 2 show that the isomalto-oligosaccharide containing syrups are digested in vitro significantly more slowly than maltodextrin. The rate data shows that maltodextrin is digested to glucose much faster than any of the isomalto-oligosaccharide mixtures, especially in the first 60 minutes of the assay

The rate of glucose formation can be modulated according to the carbohydrate profile of the samples. For example, as is evident from the carbohydrate profile of products C, D, and E, the levels of panose decrease and the levels of isomaltose increase as reaction time increases in this reaction. Products with more panose, such as C, are digested at a faster rate than samples with more isomaltose, such as E. Therefore, reaction conditions can be chosen in accordance with the desired rate of release of glucose.

### Example 6

### Nutritional Drink

Isomalto-oligosaccharide (IMO-900) (65 g), maltodextrin (35 g) (e.g. MALTRIN® M100), protein (50 g) (e.g. soy, meat or whey), fat (50 g) (e.g. from safflower oil) and water (800 g) are blended to form a nutritional drink.

### Example 7

### Energy Bar

Whole grain rolled oats (40 g), isomalto-oligosaccharide (IMO-900) (25 g), brown rice (10 g), and less than 10 g of peanut butter, sugar, canola oil, soy protein, peanut flour, soy lecithin, baking soda are blended to form an energy bar.

While the invention has been described with respect to specific examples including presently preferred modes of carrying out the invention, those skilled in the art will appreciate that there are numerous variations and permutations of the above-described systems and techniques that fall within the scope of the invention as set forth in the appended claims. Accordingly, no non-claimed language should be deemed to limit the scope of the invention, but rather this invention includes all modifications and equivalents of the subject matter recited in the claims appended hereto as permitted by applicable law. All methods and procedures described herein can be performed in any suitable order. All references cited herein are hereby incorporated by reference in their entireties.

1. A nutritive food product comprising an isomalto-oligosaccharide and at least one other nutritive caloric source, at least 35% of the nutritive caloric content of said food product being attributed to said isomalto-oligosaccharide.

2-4. (canceled)

5. A sustained-energy release nutritive food product comprising nutritive carbohydrates wherein at least 35% of the nutritive carbohydrates comprise an isomalto-oligosaccharide

6-8. (canceled)

9. A method for preparing a nutritive carbohydrate mixture from a starting carbohydrate that has α(1,4) glucosidic bonds, said nutritive carbohydrate being enriched in glucosidic bonds other than α(1,4) bonds, comprising:
selecting a desired carbohydrate profile for said nutritive carbohydrate mixture;
selecting a starting material and reaction conditions suitable to obtain a nutritive carbohydrate material that includes approximately said carbohydrate profile.

10. A method for preparing a nutritive food product, comprising:
providing an isomalto-oligosaccharide;
blending said isomalto-oligosaccharide with an additional nutritive carbohydrate to form a nutritive food product, at least 35% of the nutritive carbohydrates in said food product comprising said isomalto-oligosaccharide

11-15. (canceled)

16. A method for preparing a nutritive food product, comprising:
providing an isomalto-oligosaccharide;
blending said isomalto-oligosaccharide with an additional caloric source to form a nutritive food product, at least 35% of the nutritive caloric content of said food product attributed to said isomalto-oligosaccharide.

17-21. (canceled)

22. A nutritive product in the form of a discrete food product, said food product comprising an isomalto-oligosaccharide and at least one other nutritive caloric source, whereby the nutritive caloric content of said isomalto-oligosaccharide is at least 50 kcal.

23-27. (canceled)
